(19) United States
(12) Patent Application Publication
(10) Pub. No.: US 2015/0192154 A1
(43) Pub. Date: Jul. 9, 2015

(54) TORSIONAL MEMBERS AND METHODS OF MAKING AND USING THE SAME

(71) Applicant: GM Global Technology Operations LLC, Detroit, MI (US)

(72) Inventor: Christopher G. Basela, Ortonville, MI (US)

(73) Assignee: GM Global Technology Operations LLC, Detroit, MI (US)

(21) Appl. No.: 14/150,167

(22) Filed: Jan. 8, 2014

(51) Int. Cl. F16B 1/00

(52) U.S. Cl. CPC F16B 1/00

(57) ABSTRACT

A number of variations may include a torsional member and method of manufacture thereof wherein the torsional member may be fabricated from a core, a shell, and a bonding agent, wherein at least one of the shell or the core comprises a pultruded material comprising carbon.

### TECHNICAL FIELD

The field to which the disclosure generally relates to includes torsional members including, but not limited to, materials used in vehicle frames and structures, such as, but not limited to frames or structures included in passenger vehicles, motor cycles, bicycles, rough terrain vehicles, watercraft, trains, aircraft, or spacecraft, as well as structural material used in the fields of sports & leisure, construction, civil engineering, machining, and other various technical fields.

### BACKGROUND

Currently, some torsional members may be formed from metal to provide bracing to frames and structures in some vehicles or other applications.

### SUMMARY OF ILLUSTRATIVE VARIATIONS

One variation of the invention shows a product comprising a shell, a core, and a bonding agent, wherein the shell at least partially overlays the core, wherein at least one of the shell or the core comprises a pultruded material comprising carbon.

Another variation of the invention shows a method of manufacturing a torsional member comprising: providing a shell, a core, and a bonding agent, pultruding at least one of the shell or the core through a bonding agent wherein at least some of the bonding agent contacts the core or the shell, positioning the shell over at least a portion of the core, and curing to form the torsional member, wherein at least one of the shell or the core comprises carbon.

Other illustrative variations within the scope of the invention will become apparent from the detailed description provided hereinafter. It should be understood that the detailed description and specific examples, while disclosing optional variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a cross-sectional and perspective view of one variation of the torsional member.

FIG. 2A is a cross-sectional view of one variation of the insert.

FIG. 2B is a cross-sectional view of one variation of the insert.

FIG. 2C is a cross-sectional view of one variation of the insert.

### DETAILED DESCRIPTION OF ILLUSTRATIVE VARIATIONS

The following description of the variations is merely illustrative in nature and is in no way intended to limit the scope of the invention, its application, or uses.

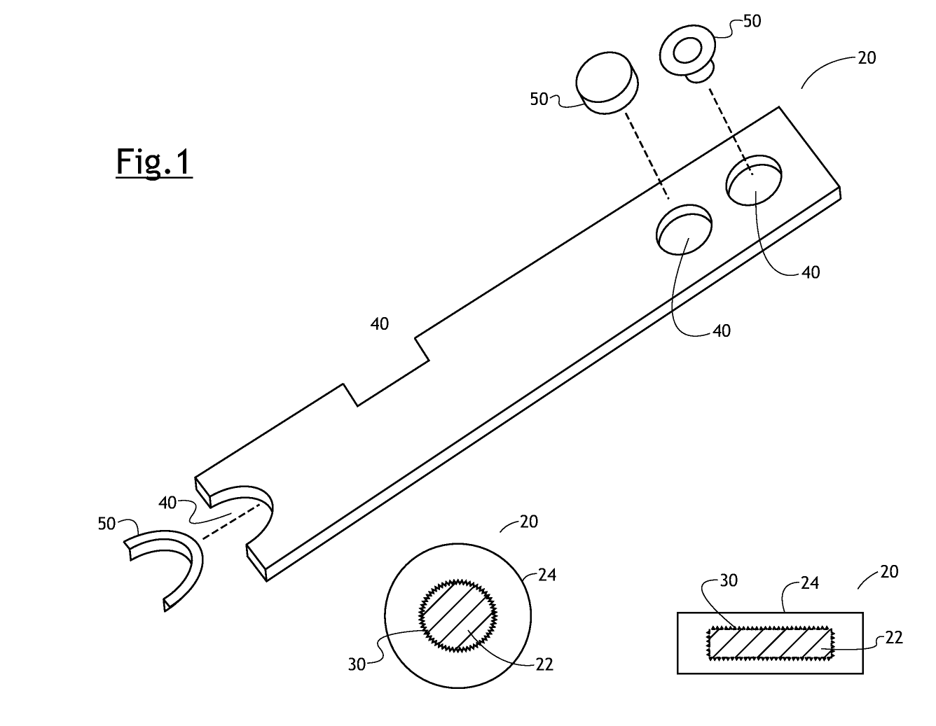

A torsional member 20 is provided in FIG. 1. Such a torsional member 20 may be useful in applications such as frames, beams, springs, or other structures used in vehicles or may be used for other applications. The torsional member 20 may provide high strength to mass ratio over other torsional materials such as metal. The torsional member 20 may provide a spring back effect to its original shape. In one variation, the torsional member 20 may include a plurality of layers. In one variation, the torsional member 20 may include a core 22. The core 22 may include a plurality of fibers. The fibers may be textile, natural or synthetic or may be another type. The fibers in the core 22 may include animal, vegetable, or mineral fibers including, but not limited to, alpaca, angora, byssus, camel hair, cashmere, catgut, chiengora, guanaco, llama, mohair, pashmina, qiviut, rabbit, silk, sinew, spider silk, wool, vicuna, yak, abaca′, bagasse, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid (including Twaron, Kevlar, Technora, Nomex), microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, and S-glass, or may be another type), basalt, aluminum, or may be another type. The core 22 may contain combinations of the above in varying concentrations and the components may be intermixed. Additional woven composite filament may also be formed from these components. The core 22 or the woven composite filament may be formed by sheets, continuous mats, or as continuous filaments. The core 22 may be formed using a hand lay-up operation, a spray lay-up operation, a pultrusion operation, a chopped strand mat, vacuum bag moulding, pressure bag moulding, autoclave moulding, resin transfer moulding, vacuum assisted resin transfer moulding, bladder moulding, compression moulding, mandrel wrapping, wet layup, chopper gun, filament winding, melting, staple fiber, continuous filament, or may be formed another way. The core 22 can be manufactured in a two dimensional or three dimensional orientation. The core 22 may include short-fiber reinforced materials or continuous fiber-reinforced materials or may include another type. The core 22 may be manufactured or woven through weaving, knitting, braiding, stitching, plain weaving, satin weaving, or may be manufactured in another way. The core 22 may have various widths, lengths and/or diameters of fibers as well as in its overall dimensions. The core 22 may be preimpregnated, coated, or otherwise in contact with a bonding agent 30.

Still referring the FIG. 1, the torsional member 20 may further include a shell 24. The shell 24 may include a plurality of fibers. The fibers may be textile, natural or synthetic or may be another type. The fibers in the shell 24 may include animal, vegetable, or mineral fibers including, but not limited to, alpaca, angora, byssus, camel hair, cashmere, catgut, chiengora, guanaco, llama, mohair, pashmina, qiviut, rabbit, silk, sinew, spider silk, wool, vicuna, yak, abaca′, bagasse, bamboo, coir, cotton, flax, hemp, jute, kapok, kenaf, pina, raffia, ramie, sisal, wood, asbestos, acetate, triacetate, art silk, lyocell rayon, silica, modal rayon, rayon, glass, carbon, basalt, metallic, acrylic, aramid (including Twaron, Kevlar, Technora, Nomex), microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, and S-glass, or may be another type), basalt, aluminum, or may be another type. The shell 24 may contain combinations of the above in varying concentrations and the components may be intermixed. Additional woven composite filament may also be formed from these components. The shell 24 may be formed by sheets, continuous mats, or as continuous filaments. The shell 24 may be formed using a hand lay-up operation, a spray lay-up operation, a pultrusion operation, a chopped strand mat, vacuum bag moulding, pressure bag moulding, autoclave moulding, resin transfer moulding, vacuum assisted resin transfer moulding, bladder moulding, compression moulding, mandrel wrapping, wet layup, chopper gun, filament winding, melting, staple fiber, continuous filament, or may be formed another way. The shell 24 can be manufactured in a two dimensional or three dimensional orientation. The shell 24 may include short-fiber reinforced materials or continuous fiber-reinforced materials or may include another type. The shell 24 may be manufactured or woven through weaving, knitting, braiding, stitching, plain weaving, satin weaving, or may be manufactured in another way. The shell 24 may have various widths, lengths and/or diameters of fibers as well as in its overall dimensions. The shell 24 may be preimpregnated, coated, or otherwise in contact with a bonding agent 30.

Referring to FIG. 1, the torsional member 20 may be machined to form at least one hole 40 within the torsional member 20. The hole 40 may be defined as an opening within or on the side of the torsional member 20. The hole 40 may be circular, polygonal, half circular, u-shaped, or may be another type. The hole 40 may be punched, machine routered, or may be formed another way. At least one insert 50 may be positioned into contact with the hole 40. The insert 50 may attach the torsional member 20 to other components, braces, or compartments in a vehicle, or may be used another way. The insert 50 may act as a galvanic corrosion isolator to a body attachment point or a fastener to a body attachment point and allow for higher torque loading. The insert 50 may be any shape including, but not limited to, a circle, a parabola, a half circle, an ellipse, a polygon, a triangle, or may be another shape. The insert 50 may comprise prongs. The term prong may be defined as a projection of the insert 50 in the direction of a different plane from the rest of the insert 50. The insert 50 may be comprised of a metal, polymer, textile, or may be another type. In one variation, the insert 50 may be metal in the form of an element, compound, or alloy. In one variation, the insert 50 metal may comprise titanium, steel, cast iron, alloy steel, stainless steel, platinum, palladium, aluminum, copper, nickel, iron, lead, tin, cobalt, bronze, or may be another type. In one variation, the insert 50 may comprise a textile comprising an animal textile, a plant textile, a mineral textile, or a synthetic textile. In one variation, the insert 50 may comprise a composite material including, but not limited to, a fiber-reinforced polymer, a thermoplastic composite, a metal matrix composite, a ceramic matrix composite, an organic matrix composite, a fiber-reinforced composite, a polyester, a vinyl ester, an epoxy, a phenolic polymer, a polyimide polymer, a polyamide polymer, a polypropylene, PEEK, or may be another type. The insert 50 may be pre machined through a stamp and roll or may be machined another way. The insert 50 may be a bearing including a plain bearing, rolling-element bearing, jewel bearing, fluid bearing, magnetic bearing, flexure bearing, or may be another type. The insert 50 may be a plain bearing and may be an integral type, bushing type, two-piece type, or may be another type.

Still referring to FIG. 1, a bonding agent 30 may be held in contact with the core 22, shell 24, or insert 50. This contact may result in adherence or bonding between the bonding agent 30, the core 22, shell 24, or insert 50, or any combination thereof. The bonding agent 30 may include urethane resin, vinylester resin, polyester resin, epoxy resin, phenolic resin, modified phenolic resin or may be another type. The bonding agent 30 may be reactive or non-reactive.

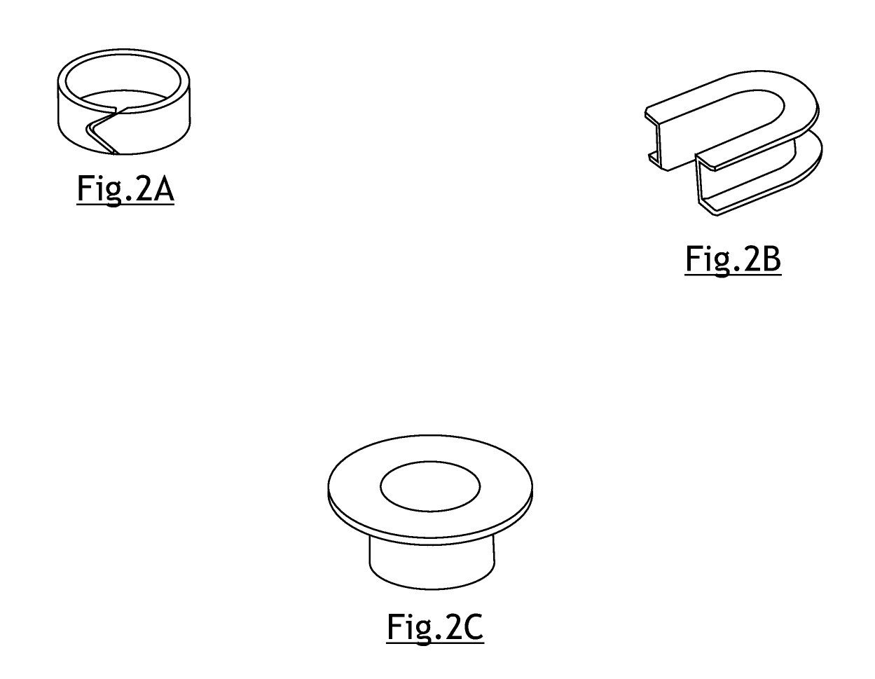

Referring to FIGS. 2A-2C, the insert 50 may comprise a different shape. Referring to FIG. 2A, the insert 50 may comprise a split ring shape. The split shape may be any pattern. Referring to FIG. 2B, the insert 50 may comprise a U-shape. The insert 50 may comprise prongs on both or one side of the U or may comprise prongs anywhere on the insert 50. Referring to FIG. 2C, the insert 50 may comprise a cylinder. The insert 50 may comprise a prong on a side or top of the cylinder or may comprise prongs anywhere on the insert 50. The insert 50 may contain serrations or knearling for attachment to either the torsional member 20 or to an attachment (not shown). The insert 50 may contain an adhesive for attachment to either the torsional member 20 or to an attachment (not shown). An attachment may be defined as anything to which a torsional member 20 can attach to. The adhesive may be a metal epoxy, resin, silicone, polyurethane, polysifide, cyanoacrylate, UV-cure, or may be another type.

The torsional member 20 may be produced by various fabrication or manufacturing methods. The torsional member 20 may be in two or three dimensional orientation. The core 22 or shell 24, or both or neither may be manufactured or woven through weaving, knitting, braiding, stitching, plain weaving, satin weaving, or may be manufactured another way. In one variation, at least one of a weave, a knit, a braid, a stitch, a plain weave, or a satin weave can be added to the core 22, to the shell 24, to both or to neither during manufacture or fabrication. Some examples of orientations of the at least one of a weave, a knit, a braid, a stitch, a plain weave, or a satin weave include, but are not limited to, 90 degree, 45 degree, or 60 degree or may be another degree. In one variation, fibers in the core 22 or the shell 24 or both or neither may be bundled prior to manufacture or may be bundled during manufacture. In one variation the core 22 may be pultruded by a tension roller and contacted with a bonding agent 30. In one variation the shell 24 may be pultruded by a tension roller and contacted with a bonding agent 30. In one variation both the core 22 and the shell 24 may be pultruded by a tension roller and contacted with a bonding agent. The core 22, the shell 24, or both or neither may be held in contact and cured to form a torsional member 20. In one variation the shell 24 may at least partially overlay the core 22. In one variation, the core 22 and the shell 24 may be held together in contact by a tension roller. In one variation the core 22 and shell 24 may be formed from pultrusion. In one variation the core 22 and the shell 24 may be pultruded through a molding head. In one variation the core 22 or the shell 24 may be pultruded through a molding head. In one variation additional woven composite filament fibers may be added to either the core 22 or the shell 24. In one variation, a sweep can be added to the torsional member 20 to form a desired shape before the torsional member 20 may be completely cured. The sweep can be any level of degree as necessary for a desired application. Some examples of sweep include, but are not limited to, 90 degree, 45 degree, or 60 degree or may be another degree. In one variation, a sweep may be added through a curved track. The torsional member 20 may be cut to a desired length for a desired application. The torsional member 20 may be machined, cut, pierced, or routered to form at least one hole 40 in the torsional member 20, or the hole 40 may be added another way. At least one insert 50 may be positioned in contact with the hole 40. The insert 50 may include serrations, knearling, or an adhesive for contact with the hole 40 or to an attachment. Other methods may be used to form the torsional member 20. These methods include, but are not limited to, hand lay-up operation, a spray lay-up operation, a chopped strand mat, vacuum bag moulding, pressure bag moulding, autoclave moulding, resin transfer moulding, injection moulding, vacuum assisted resin transfer moulding, bladder moulding, compression moulding, mandrel wrapping, face sheet rolling, wet layup, chopper gun, filament winding, or may be formed another way. The torsional member 20 may be formed to sheets in an orientation of the core 22, shell 24, and bonding agent 30 in any combination or layer formation. The torsional member 20 may be finished with other methods for a final design. A mold may be tooled to form the desired shape or variation of the torsional member 20 for its intended application. A person of skill in the art would recognize these techniques. The torsional member 20 may contain a mass weight of 47% carbon. A pultruded material may be defined as any material that has undergone pultrusion.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product including a torsional member including a shell, a core, and a bonding agent, wherein the shell at least partially overlays the core, wherein at least one of the shell or the core includes a pultruded material including carbon.

Variation 2 may include a product as set forth in Variation 1 wherein at least one hole is formed in the product.

Variation 3 may include a product as set forth in any of Variations 1-2 wherein at least one insert is positioned in contact with the hole.

Variation 4 may include a product as set forth in any of Variations 1-3 wherein the insert is a split ring.

Variation 5 may include a product as set forth in any of Variations 1-4 wherein the insert is a double pronged U shape.

Variation 6 may include a product as set forth in any of Variations 1-5 wherein the insert is a single pronged cylinder shape.

Variation 7 may include a product as set forth in any of Variations 1-6 in which the insert comprises at least one of serrations, knearling, or an adhesive layer.

Variation 8 may include a product as set forth in any of Variations 1-7 in which the insert includes a metal including at least one of stainless steel or titanium.

Variation 9 may include a product as set forth in any of Variations 1-8 wherein the core further includes a pultruded material including glass.

Variation 10 may include a product as set forth in any of Variations 1-9 wherein the shell further comprises at least one fiber comprising at least one of alpaca, angora, byssus, camel hair, cashmere, catgut, chiengora, guanaco, llama, mohair, pashmina, qiviut, rabbit, silk, sinew, spider silk, wool, vicuna, yak, abaca′, bagasse, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass, basalt, or aluminum.

Variation 11 may include a product as set forth in any of Variations 1-10 wherein the bonding agent includes a resin including at least one of vinylester resin, polyester resin, epoxy resin, phenolic resin, or modified phenolic resin.

Variation 12 A method of manufacturing a torsional member including: providing a shell, a core, and a bonding agent, pultruding at least one of the shell or the core through a bonding agent wherein at least some of the bonding agent contacts the core or the shell, positioning the shell over at least a portion of the core, and curing to form the torsional member, wherein at least one of the shell or the core comprises carbon.

Variation 13 may include a method as set forth in Variation 12 further including: cutting the torsional member, forming at least one hole in the torsional member, and positioning at least one insert in contact with the hole.

Variation 14 may include a method as set forth in any of Variations 12-13 wherein the bonding agent includes a resin including at least one of vinylester resin, polyester resin, epoxy resin, phenolic resin, or modified phenolic resin.

Variation 15 may include a method as set forth in Variations 12-14 wherein the insert is a split ring.

Variation 16 may include a method as set forth in any of Variations 12-15 wherein the insert is a double pronged U shape.

Variation 17 may include a method as set forth in any of Variations 12-16 wherein the insert is a single pronged cylinder shape.

Variation 18 may include a method as set forth in any of Variations 12-17 wherein the insert includes at least one of serrations, knearling, or an adhesive layer.

Variation 19 may include a method as set forth in any of Variations 12-18 wherein insert includes a metal including at least one of stainless steel or titanium.

Variation 20 may include a method as set forth in any of Variations 12-19 wherein the core further includes a pultruded material including glass.

Variation 21 may include a product as set forth in any of Variations 1-11 wherein the torsional member includes a plurality of layers. in a two dimensional or three dimensional orientation.

Variation 22 may include a product as set forth in any of Variations 1-11 and 21 wherein the core includes at least one fiber including at least one of alpaca, angora, byssus, camel hair, cashmere, catgut, chiengora, guanaco, llama, mohair, pashmina, qiviut, rabbit, silk, sinew, spider silk, wool, vicuna, yak, abaca′, bagasse, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid (including Twaron, Kevlar, Technora, Nomex), microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass, basalt, or aluminum.

Variation 23 may include a product as set forth in any of Variations 1-11 and 21-22 further including a woven composite filament including at least one fiber including at least one of alpaca, angora, byssus, camel hair, cashmere, catgut, chiengora, guanaco, llama, mohair, pashmina, qiviut, rabbit, silk, sinew, spider silk, wool, vicuna, yak, abaca′, bagasse, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid (including Twaron, Kevlar, Technora, Nomex), microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass, basalt, or aluminum.

Variation 24 may include a product as set forth in any of Variations 1-11 and 21-23 wherein the core includes short-fiber reinforced materials or continuous fiber-reinforced materials.

Variation 25 may include a product as set forth in any of Variations 1-11 and 21-24 wherein the shell is formed by sheets, continuous mats, or as continuous filaments.

Variation 26 may include a product as set forth in any of Variations 1-11 and 21-25 wherein the core is formed by sheets, continuous mats, or as continuous filaments.

Variation 27 may include a product as set forth in any of Variations 1-11 and 21-26 wherein the shell may be manufactured in a two dimensional or three dimensional orientation.

Variation 28 may include a product as set forth in any of Variations 1-11 and 21-27 wherein at least one of the core or the shell is manufactured by at least one of weaving, knitting, braiding, stitching, plain weaving, or satin weaving.

Variation 29 may include a product as set forth in any of Variations 1-11 and 21-28 wherein the shell includes short-fiber reinforced materials or continuous fiber-reinforced materials.

Variation 30 may include a product as set forth in any of Variations 1-11 and 21-29 wherein the shell is formed by sheets, continuous mats, or as continuous filaments.

Variation 31 may include a product as set forth in any of Variations 1-11 and 21-30 wherein the hole is circular, polygonal, half circular, or u-shaped.

Variation 32 may include a product as set forth in any of Variations 1-11 and 21-31 wherein the insert is formed in the shape of a circle, a parabola, a half circle, an ellipse, a polygon, or a triangle.

Variation 33 may include a product as set forth in any of Variations 1-11 and 21-32 wherein the insert includes at least one of titanium, steel, cast iron, alloy steel, stainless steel, platinum, palladium, aluminum, copper, nickel, iron, lead, tin, cobalt, or bronze.

Variation 34 may include a product as set forth in any of Variations 1-11 and 21-33 wherein the insert includes at least one of a fiber-reinforced polymer, a thermoplastic composite, a metal matrix composite, a ceramic matrix composite, an organic matrix composite, a fiber-reinforced composite, a polyester, a vinyl ester, an epoxy, a phenolic polymer, a polyimide polymer, a polyamide polymer, a polypropylene, or PEEK.

Variation 35 may include a product as set forth in any of Variations 1-11 and 21-34 wherein the insert includes a bearing including at least one of a plain bearing, rolling-element bearing, jewel bearing, fluid bearing, magnetic bearing, or a flexure bearing.

Variation 36 may include a product as set forth in any of Variations 1-11 and 21-35 wherein the insert includes a plain bearing including at least one of an integral type, bushing type, or a two-piece type.

Variation 37 may include a product as set forth in any of Variations 1-11 and 21-36 wherein the bonding agent is reactive.

Variation 38 may include a product as set forth in any of Variations 1-11 and 21-37 wherein the adhesive includes one of metal epoxy, resin, silicone, polyurethane, polysifide, cyanoacrylate, or a UV-cure.

Variation 39 may include a method as set forth in any of Variations 12-20 wherein at least one of the core or the shell includes at least one of a weave, a knit, a braid, a stitch, a plain weave, or a satin weave of any degree.

Variation 40 may include a product as set forth in any of Variations 1-11 and 21-38 wherein at least one of the core or the shell includes at least one of a weave, a knit, a braid, a stitch, a plain weave, or a satin weave of any degree.

Variation 41 may include a method as set forth in any of Variations 12-20 and 39 wherein the torsional member is formed by at least one of a hand lay-up operation, a spray lay-up operation, a chopped strand mat, vacuum bag moulding, pressure bag moulding, autoclave moulding, resin transfer moulding, injection moulding, vacuum assisted resin transfer moulding, bladder moulding, compression moulding, mandrel wrapping, wet layup, chopper gun, or filament winding.

Variation 42 may include a method as set forth in any of Variations 12-20, 39 and 41 wherein at least one of the core or the shell is pultruded by a tension roller through a molding head.

Variation 43 may include a method as set forth in any of Variations 12-20, 39 and 41-42 wherein a sweep is added to the torsional member in any degree.

Variation 44 may include a product as set forth in any of Variations 1-11, and 21-38, and 40 wherein the torsional member includes a mass weight of 47% carbon.

The above description of select variations is merely illustrative in nature and, thus, variations or variants thereof are not to be regarded as a departure from the spirit and scope of the invention.

What is claimed is:

1. A product comprising:
a shell, a core, and a bonding agent, wherein the shell at least partially overlays the core, wherein at least one of the shell or the core comprises a pultruded material comprising carbon.

2. A product as set forth in claim 1 wherein at least one hole is formed in the product.

3. A product as set forth in claim 2 wherein at least one insert is positioned in contact with the hole.

4. A product as set forth in claim 3 wherein the insert is a split ring.

5. A product as set forth in claim 3 wherein the insert is a double pronged U-shape.

6. A product as set forth in claim 3 wherein the insert is a single pronged cylinder shape.

7. A product as set forth in claim 3 wherein the insert comprises at least one of serrations, knearling, or an adhesive layer.

8. A product as set forth in claim 3 wherein the insert comprises a metal comprising at least one of stainless steel or titanium.

9. A product as set forth in claim 1 wherein the core further comprises a pultruded material comprising glass.

10. A product as set forth in claim 1 wherein the shell further comprises at least one fiber comprising at least one alpaca, angora, byssus, camel hair, cashmere, catgut, chiengora, guanaco, llama, mohair, pashmina, qiviut, rabbit, silk, sinew, spider silk, wool, vicuna, yak, abaca′, bagasse, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass, basalt, or aluminum.

11. A product as set forth in claim 1 wherein the bonding agent comprises a resin comprising at least one of vinylester resin, polyester resin, epoxy resin, phenolic resin, or modified phenolic resin.

12. A method of manufacturing a torsional member comprising:
providing a shell, a core, and a bonding agent,
pultruding at least one of the shell or the core through a bonding agent, wherein at least some of the bonding agent contacts the core or the shell,
positioning the shell over at least a portion of the core,
and curing to form the torsional member, wherein at least one of the shell or the core comprises carbon.

13. A method as set forth in claim 12 further comprising:
cutting the torsional member,
forming at least one hole in the torsional member, and
positioning at least one insert in contact with the hole.

14. A method as set forth in claim 12 wherein the bonding agent comprises at least one of vinylester resin, polyester resin, epoxy resin, phenolic resin, or modified phenolic resin.

15. A method as set forth in claim 13 wherein the insert is a split ring.

16. A method as set forth in claim 13 wherein the insert is a double pronged U-shape.

17. A method as set forth in claim 13 wherein the insert is a single pronged cylinder shape.

18. A method as set forth in claim 13 wherein the insert comprises at least one of serrations, knearling, or an adhesive layer.

19. A method as set forth in claim 13 wherein the insert comprises a metal comprising at least one of stainless steel or titanium.

20. A method as set forth in claim 12 wherein the core further comprises a pultruded material comprising glass.
